(19) United States
(12) Patent Application Publication
(10) Pub. No.: US 2025/0298580 A1
(43) Pub. Date: Sep. 25, 2025

(54) System and Method for Automated Code Generation and Verification in Notebook based Integrated Development Environments

(71) Applicant: Anthony Patrick Mauro, II, San Rafael, CA (US)

(72) Inventor: Anthony Patrick Mauro, II, San Rafael, CA (US)

(21) Appl. No.: 19/060,735

(22) Filed: Feb. 23, 2025

Related U.S. Application Data
(60) Provisional application No. 63/557,500, filed on Feb. 24, 2024.

(51) Int. Cl. G06F 8/30

(52) U.S. Cl. CPC G06F 8/30

(57) ABSTRACT

A system and method for automated code generation and verification in notebook-based integrated development environments (IDEs) is disclosed. The system and method includes generating a master notebook, with cells including tags identifying the content specific to intended versions; generating a student notebook and a teacher notebook from the master notebook, wherein the student notebook includes the text cells and the code cells, but not the test cells, and the teacher notebook includes the text cells, the code cells, and the test cells; and grading the completed notebook. This system and method improves the management and automated generation and grading of assignments in notebook-based IDEs, particularly for educational purposes.

### CLAIM OF PRIORITY

A claim of priority is made to the following U.S. Provisional Application No. 63/557,500 entitled “SYSTEM AND METHOD FOR AUTOMATED CODE GENERATION AND VERIFICATION IN NOTEBOOK BASED INTEGRATED DEVELOPMENT ENVIRONMENTS” filed Feb. 24, 2024, and assigned to the assignee hereof and hereby expressly incorporated by reference herein.

### TECHNICAL FIELD

This invention relates to systems and methods for automated code version generation and verification in notebook-based integrated development environments (IDEs), particularly addressing the challenges associated with managing and grading student submissions in notebook-based IDEs.

### BACKGROUND

The proliferation of computer science algorithm deployments has produced a myriad of Integrated Development Environments (IDEs) to develop, execute and test software programs (code) in various languages. Additionally, cloud-based platforms have become common, serving as the IDEs and repositories for design documents and implementation code. Some examples of the applications using cloud-based IDEs to develop, execute, and test algorithms include, but are not limited to, Machine Learning and Artificial Intelligence (ML and AI), Cybersecurity, and High-level Description Language (HDL) circuit design to name a few.

The result of the expansive development of new algorithms and implementations has increased the need for education in the field of computer science at the secondary and post-secondary level, especially in the example areas mentioned. Further, the evolution and convenience of cloud-based IDEs as teaching tools has seen more adoption at the secondary and post-secondary levels. For example, literate programming, as described by Donald Knuth, is a common approach to teaching programming and algorithm development concepts by combining both textual, natural language descriptions and short coding assessments in a “cell” based environment. The combination of textual, natural language descriptions and coding assessments in an IDE is sometimes referred to as “notebooks”. This technique, though convenient and effective, has resulted in increased complexity and required efforts in grading of student submissions for educators.

As a result, a need exists for improved management and automated generation and grading in notebook-based integrated development environments to provide efficient curriculum implementations.

### SUMMARY

The system and method described herein provide for creating various versions of and subsequently grading Jupyter Notebooks.

In one exemplary embodiment, a teacher uploads a master notebook to a version splitter application. The version splitter application parses the master notebook, identifies tags to indicate modifications for student and teacher versions, and generates the versions accordingly. The student version has solution code removed, while the teacher version retains all content and acts as a reference.

In another exemplary embodiment, the teacher uploads completed student notebooks to an autograder application. The autograder application executes the code cells in the student notebooks, compares the outputs to expected results, and generates a grade for each student.

This system and method improves the management and automated generation and grading of assignments in notebook-based IDEs, particularly for educational purposes

### DESCRIPTION OF DRAWINGS

FIG. 1. illustrates an exemplary procedure to create, assign, and grade a literate programming assignment.

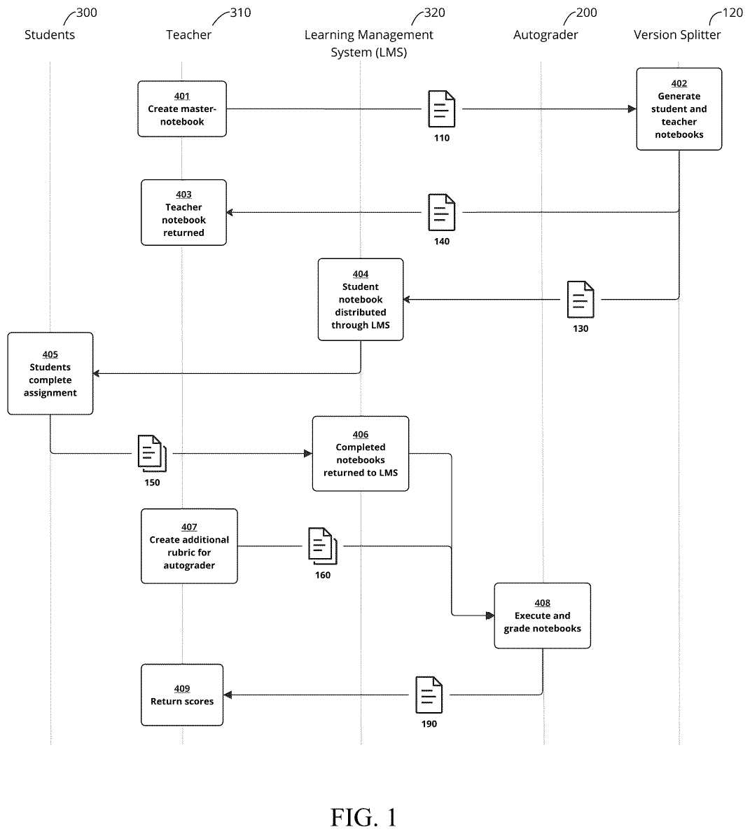

FIG. 2. depicts the system architecture, showing the process of generating student and teacher versions from a master notebook using a version splitter and the subsequent verification of the student versions.

FIG. 3. depicts a directory housing student notebooks created by learning management system Google Classroom in one exemplary embodiment

FIG. 4. illustrates the procedure of the Version Splitter application.

FIG. 5. illustrates the procedure of the Autograder application.

### DETAILED DESCRIPTION

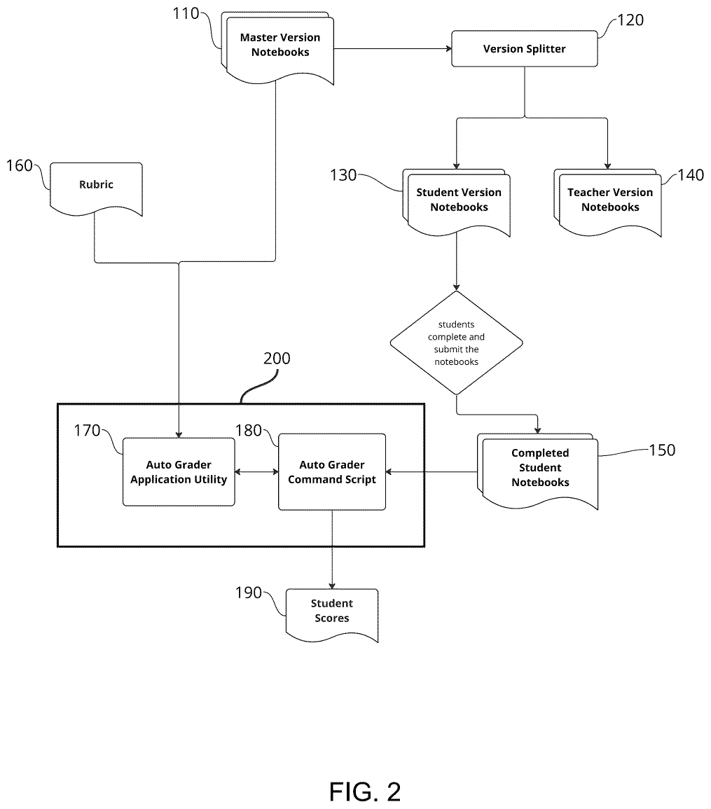

The systems and methods described herein provide for creating various versions of and subsequently grading Jupyter Notebooks. An instructor may utilize literate programming to create a master notebook for an assignment from which a student version can be derived with the solution code removed, and a fully-functioning teacher version can be created to act as a reference. In this way, a student receives instruction through some cells incorporating textual or natural language descriptions, and other cells containing coding assessments. The master notebook for an assignment or task may include any code or instructions required for all users, such as a teacher and students. In FIG. 2, a plurality of master notebooks 110 are stored on a storage drive. The drive may be located in the cloud, on a local area network, or on an individual device such as a laptop computer.

The content in the master notebook that is meant to be modified or removed for a student version may be bracketed with an uncommon combination of characters, hereinafter referred to as a tag, that is not present in the content of the assignment. Any number or variation of tags may be used to remove or replace the content in the master file. For example, a variable initialization could be bracketed by “+++” and replaced with “______” to indicate that a student must edit that line of code as part of the assignment, or cells containing test code could begin with “#TEST” to be removed from the student's file. The test code may include, but is not limited to, commands from the Python doctest library. Any number of versions of the file to be assigned can also be made using this method of tagging content to be removed or replaced.

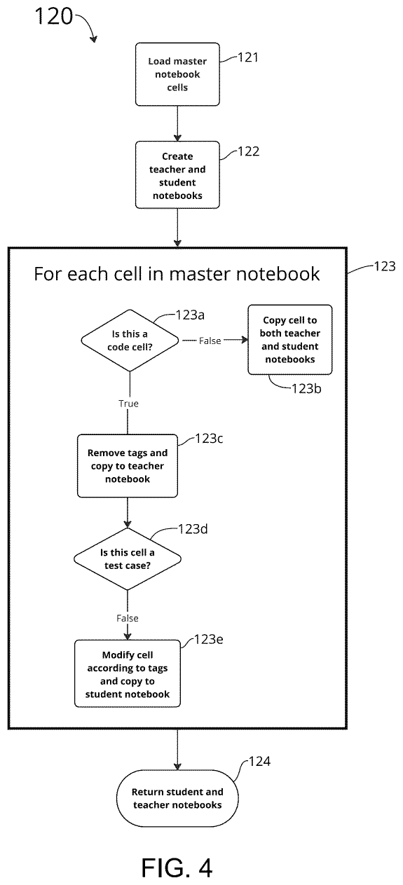

In an exemplary embodiment, a student notebook 130 and teacher notebook 140 is created from a master notebook. The system and method depicted in FIG. 4 may be implemented in a single application as shown in FIG. 2 or split between one or more command scripts and application utilities. The Version Splitter 120 can utilize Python notebook utilities (for example, nbformat and Regular Expression) to create different versions of the master notebook in order based upon the tags present in the code file. The Version Splitter 120 may parse the storage drive and create a list of the master notebooks 110 stored on the drive. For each master notebook 110, Version Splitter 120 may iterate through each code cell in the master notebook and begin synthesizing the various student and teacher notebooks. Each cell may be modified or based upon its tags and then added to either the student and/or teacher notebooks. This could include removing all tags without replacing the content of the code cells to create a functional answer key for a teacher, or removing test code from a student's assignment. The student notebooks 130 and teacher notebooks 140 are saved to the storage drive.

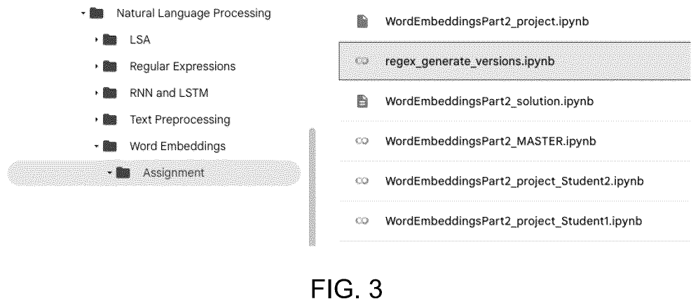

These newly synthesized notebooks may then be sent to a learning management system (LMS), such as Google Classroom, Canvas, Blackboard, etc. to be utilized as an educational assignment. Participants in the course may access the notebook through the learning management system and fill in or modify the cells as described in the text cells of the file. The completed assignments may be submitted to the teacher or other administrator through the learning management system for scoring. In the embodiment depicted in FIG. 3, an instructor utilizes Google Classroom to distribute and collect class assignments. For each assignment, a folder is automatically created and contains the student submissions.

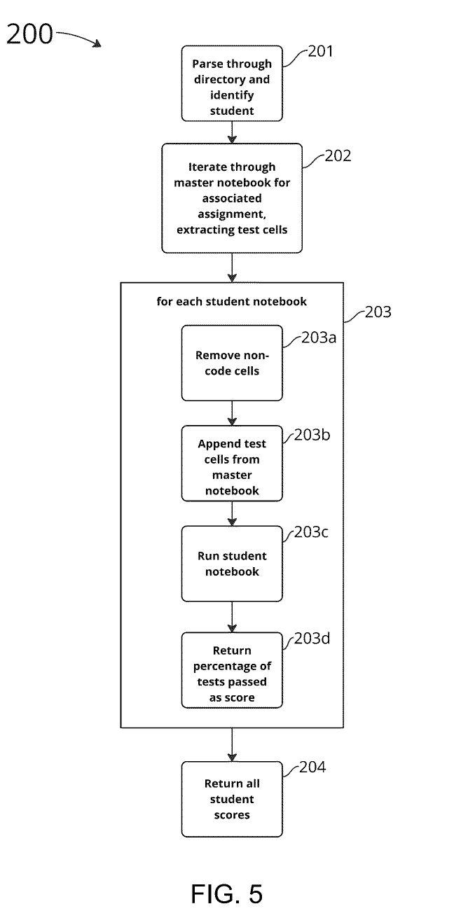

To support a second efficient curriculum implementation, an instructor may utilize an automatic grading application to execute and test a student submission of a notebook. The system and method depicted in FIG. 5 may be implemented in a single application or split between one or more command scripts and application utilities as shown in FIG. 2. A plurality of student notebooks 150 may be stored on a storage drive. The drive may be located in the cloud (for example, Google Classroom drive), on a local area network, or on an individual device such as a laptop computer. A command script 170 parses the storage drive and creates a list of the student notebooks stored on the drive. The command script 170 may then iterate through each student notebook in the list and may pass a reference to the notebook, the assignment's master notebook 110, and/or an additional rubric 160 to application utility 180 to process the files. The command script receives a message from the application utility with the test results which is saved to a results data structure. The command script may also check any two submitted notebooks for code cells that are identical, near identical, or partially identical in content, and the results are saved to a results data structure. The results data structure may then be displayed to the instructor, output to a storage drive such as grade output 190, or both.

The application utility 180 may read the parameters passed by the command script 170 and uses Python notebook utilities (for example, nbformat and os) to open the notebook and remove any cells that are not code, including but not limited to text cells and console outputs. Additionally, the application utility 180 may iterate through the master notebook 110 of the assignment and retrieve test code cells. These test cells may be added to the student notebook. The student notebook is then executed and any cells with embedded tests (for example, doctests) may display a console output of pass or fail status of a test, which may be recorded and returned to the command script 170.

The electronic and algorithmic techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), integrated or stand-alone graphics processing units (GPUs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine readable storage medium,” as the term is used herein, includes any mechanism that can store information in a form accessible by a machine (a machine may be, for example, a computer, network device, cellular phone, tablet, personal digital assistant (PDA), manufacturing tool, any device with one or more processors, etc.). For example, a machine-accessible storage medium includes recordable/non-recordable media (e.g., readonly memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

1. A method for automated management of programming documents in a notebook-based integrated development environment, comprising:
receiving a master notebook comprising a plurality of cells, wherein one or more of the cells include tags identifying content specific to intended versions;
processing, by a version-splitter application, the master notebook to generate a first notebook comprising text cells and code cells with content identified by the tags removed or modified according to predefined rules, and a second notebook comprising the text cells, the code cells, and test cells;
distributing the first notebook to one or more recipients through a document control system;
receiving completed recipient notebooks through the document control system;
executing, by an autograder application, the code cells in the completed recipient's notebooks;
comparing outputs of the executed code cells in the first notebook to expected results defined in the second notebook;
and generating a score for each recipient's notebook based on the comparison.

2. The method of claim 1, wherein the content specific to intended versions is programming instructions that implement a function.

3. The method of claim 1, wherein the first notebook is a student notebook and the second notebook is a teacher notebook.

4. The method of claim 1, wherein the recipient is a student.

5. The method of claim 1, wherein the document control system is a learning management system.

6. A system for automated code generation and verification in notebook-based integrated development environments, comprising:
a storage drive configured to store a master notebook, a generated first notebook, and a generated second notebook;
a version splitter module configured to load a master notebook comprising cells with tags identifying content specific to intended versions, process each cell in the master notebook to determine whether the cell is a code cell or a test cell, remove tags and copy content to the generated first notebook based on a first set of rules, modify cells and copy content to the generated second notebook based on a second set of rules;
and an autograder module configured to receive completed generated first notebooks, execute code cells in the generated first notebooks, compare outputs to expected results in the generated second notebook, and generate scores based on the comparison.

7. A system for automated assessment of programming assignments, comprising:
a command script configured to: parse a storage drive containing one or more first notebook submissions, create a list of first notebooks to be assessed, retrieve a master notebook containing test cases, and retrieve a grading rubric containing assessment criteria;
an application utility configured to remove non-code cells from the first notebooks, append test cases from the master notebook to the first notebooks, execute the modified first notebooks, record test execution results, and check for code similarity between the first notebook submissions;
and an output module configured to: generate a results data structure containing test results and similarity checks, calculate scores based on the results data structure and grading rubric, and store the scores in a format compatible with a document control system.
